(19) United States
(12) Patent Application Publication
(10) Pub. No.: US 2024/0207927 A1
(43) Pub. Date: Jun. 27, 2024

(54) PASTE FOR PREPARING CAPILLARY STRUCTURE AND PREPARATION METHOD THEREOF

(71) Applicant: Raytech Precision Technologies (Shuyang) Co., Ltd.

(72) Inventors: Guochuang Huang, Shenzhen (CN); Hezhi Wang, Shenzhen (CN); Bo Zhang, Shenzhen (CN); Shasha Xu, Shenzhen (CN)

(21) Appl. No.: 17/918,547

(22) PCT Filed: Aug. 23, 2022
(86) PCT No.: PCT/CN2022/114181

§ 371 Date: Oct. 12, 2022

(30) Foreign Application Priority Data
Jul. 11, 2022 (CN) 202210811241.9

(51) Int. Cl. B22F 1/065; B22F 1/054; B22F 1/107; B22F 9/04; F28D 15/04

(52) U.S. Cl. CPC B22F 1/065; B22F 1/056; B22F 1/107; B22F 9/04; F28D 15/046; B22F 2301/10

(57) ABSTRACT

The present disclosure provides paste for preparing a capillary structure, a preparation method of the paste, a preparation method of the capillary structure, and a vapor chamber. The paste includes metal powder with a mass fraction of 20-80%, compound powder with a mass fraction of 10-70%, adhesive with a mass fraction of 0.1-20%, and organic solvent with a mass fraction of 5-40%. The organic solvent dissolves the adhesive. The adhesive adheres the metal powder and the compound powder to a vapor chamber. The metal powder forms a matrix of the capillary structure in the vapor chamber after drying. The compound powder forms grooves and through holes on the matrix. The capillary structure has a controllable size to meet size requirements of the vapor chamber. The capillary structure includes the through holes and the grooves, which improves liquid absorption performance and improves heat transfer performance.

### TECHNICAL FIELD

The present disclosure relates to a technical field of vapor chambers, and in particular to paste for preparing a capillary structure, a preparation method of the paste, a preparation method of the capillary structure, and a vapor chamber.

### BACKGROUND

Electronic equipment in the prior art generates a large amount of heat during a working process. Since working performance of the electronic equipment is easily affected by temperature, in order to ensure a normal operation of the electronic equipment, the electronic equipment needs to be dissipated and cooled.

A vapor chamber and a radiator are generally installed in the electronic equipment. The vapor chamber has good thermal conductivity, which evenly distributes the heat in the electronic equipment, and then the heat is dissipated through the radiator, so as to achieve effects of heat dissipation and cooling of the electronic equipment.

However, with development of science and technology, the electronic equipment has developed in a direction of miniaturization, which has led to higher requirements for performance and sizes of internal components of the electronic equipment. In the prior art, copper foam, copper mesh, or composite copper mesh is configured as a liquid absorbing wick, which leads to a large size of the vapor chamber, leads to a thick thickness of the vapor chamber, and leads to poor liquid absorption performance of the vapor chamber. Further, it is not only unfavorable to development of the vapor chamber in directions of lightness and thinness, but also leads to poor heat transfer performance of the vapor chamber.

Therefore, it is necessary to provide paste for preparing a capillary structure, a preparation method of the paste, a preparation method of the capillary structure, and a vapor chamber to solve above problems.

### SUMMARY

Purposes of the present disclosure are to provide paste for preparing a capillary structure, a preparation method of the paste, a preparation method of the capillary structure, and a vapor chamber.

The present disclosure provides paste for preparing a capillary structure. The paste for preparing the capillary structure comprises metal powder, compound powder, adhesive, and organic solvent.

A mass fraction of the metal powder in the paste ranges from 20-80%. A mass fraction of the compound powder in the paste ranges from 10-70%. A mass fraction of the adhesive in the paste ranges from 0.1-20%. A mass fraction of the organic solvent in the paste ranges from 5-40%.

The organic solvent is configured for dissolving the adhesive. The adhesive is configured for bonding the metal powder and the compound powder to a vapor chamber. The metal powder forms a matrix of the capillary structure in the vapor chamber after drying. The compound powder forms grooves and through holes on the matrix.

In one optional embodiment, the metal powder is spherical-like copper powder. A particle size of the metal powder ranges from 0.1-100 μm.

In one optional embodiment, the compound powder comprises at least one of basic copper carbonate, basic copper sulfate, copper acetate, cuprous sulfite, ammonium cuprous sulfite, and copper ammine complex.

In one optional embodiment, a particle size of the compound powder ranges from 100-300 mesh.

In one optional embodiment, the adhesive comprises at least one of acrylic resin, epoxy resin, and phenolic resin.

In one optional embodiment, the organic solvent comprises at least one of toluene, xylene, acetone, ethanol, and terpineol.

The present disclosure further provides a preparation method of the paste for preparing the capillary structure mentioned above. The preparation method of the paste for preparing the capillary structure comprises:
grinding the compound powder and sieving the ground compound powder;
adding the adhesive into the organic solvent and stirring under heating conditions to obtain an adhesive solution, where a concentration of the adhesive solution is 5-40%; and
adding the compound powder and the metal powder into the adhesive solution and stirring to obtain the paste.

The present disclosure further provides a preparation method of the capillary structure. The preparation method of the capillary structure comprises:
coating the paste mentioned above on a cover plate of the vapor chamber;
drying the cover plate; and
sintering the cover plate; forming the capillary structure in the paste after sintering.

In one optional embodiment, a step of sintering the cover plate comprises:
sintering the cover plate in a sintering furnace, discharging gas generated by the cover plate, and introducing first gas into the sintering furnace; and
increasing a sintering temperature of the cover plate and sintering the cover plate until the paste forms the capillary structure; then introducing second gas into the sintering furnace.

The present disclosure further provides a vapor chamber. The vapor chamber comprises the cover plate and the capillary structure. The cover plate comprises a first cover plate and a second cover plate. The first cover plate covers the second cover plate. The capillary structure is disposed on the first cover plate and/or the second cover plate. The capillary structure is prepared by the preparation method of the capillary structure mentioned above. The capillary structure comprises the grooves and the through holes. The through holes are communicated with each other. A diameter of each of the through holes ranges from 10-100 μm. A porosity of the capillary structure range from 30-80%. A size of each of the grooves along a width direction of each of the grooves ranges from 10-100 μm.

The present disclosure improves a capillary effect of the capillary structure, thereby improving liquid absorption performance of the capillary structure and improving overall heat transfer performance of the vapor chamber. Meanwhile, the capillary structure has characteristics of controllable size and high quality, and a thickness of the capillary structure is controlled, so that the capillary structure meets size requirements of a thin and light vapor chamber.

### BRIEF DESCRIPTION OF DRAWINGS

FIG. 1 is a scanning electron microscope schematic diagram of a capillary structure of the present disclosure.

FIG. 2 is a flow chart of a preparation method of paste of the present disclosure.

FIG. 3 is a flow chart of a preparation method of the capillary structure of the present disclosure.

In the drawings:
1—through hole; 2—groove.

### DETAILED DESCRIPTION

The present disclosure will be further described below with reference to the accompanying drawings and embodiments.

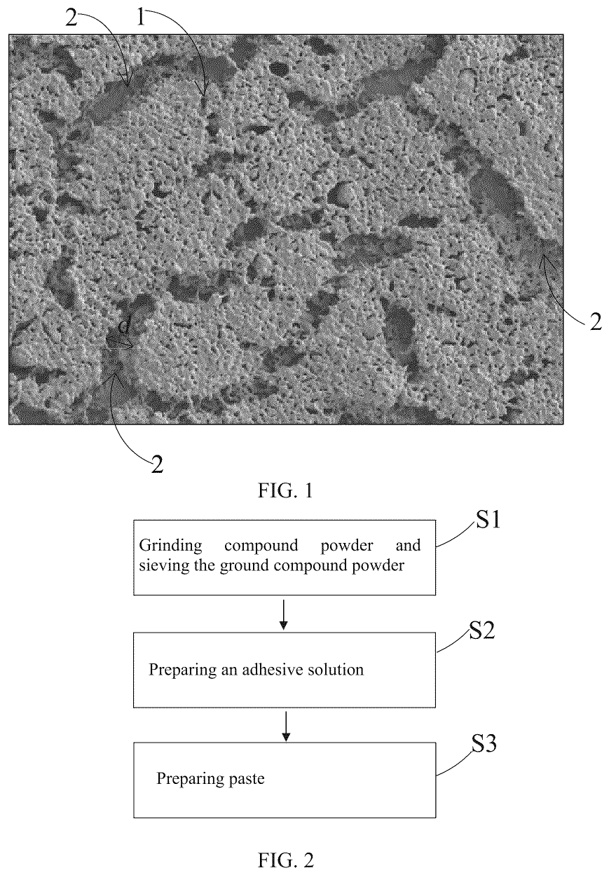

As shown in FIG. 1, the present disclosure provides paste for preparing a capillary structure. The paste for preparing the capillary structure comprises metal powder, compound powder, adhesive, and organic solvent. A mass fraction of the metal powder in the paste ranges from 20-80%. A mass fraction of the compound powder in the paste ranges from 10-70%. A mass fraction of the adhesive in the paste ranges from 0.1-20%. A mass fraction of the organic solvent in the paste ranges from 5-40%. The organic solvent is configured for dissolving the adhesive. The adhesive is configured for bonding the metal powder and the compound powder to a vapor chamber. The metal powder forms a matrix of the capillary structure in the vapor chamber after drying. The compound powder forms grooves 2 and through holes 1 on the matrix.

The liquid absorbing wick of the vapor chamber has the capillary structure. When a phase of working fluid inside the vapor chamber changes, the capillary structure provides power of backflow for the working fluid, which is beneficial to a heat conduction effect of the vapor chamber. The capillary structure is prepared from a kind of paste. In the present disclosure, the paste is copper paste. The paste comprises the metal powder, the compound powder, the adhesive, and the organic solvent. The metal powder is electrolytic copper powder, and the mass fraction of the metal powder ranges from 20-80%. In the embodiment, the mass fraction of the metal powder optionally ranges from 30-60%. The compound powder is copper salt powder. A structure of the compound powder is of micron-scale irregular shape, and the mass fraction of the compound powder ranges from 10-70%. In the embodiment, the mass fraction of the compound powder optionally ranges from 20-50%. The adhesive is decomposed and volatilized under high temperature conditions, and the adhesive bonds the metal powder and the compound powder, so that the metal powder and the compound powder are attached to the cover plate of the vapor chamber. Moreover, the adhesive is conducive to increasing the number of the through holes 1 in the capillary structure. The mass fraction of the adhesive ranges from 0.1-20%, and in the embodiment, the mass fraction of the adhesive optionally ranges from 1-15%. The organic solvent is configured for dissolving the adhesive. The mass fraction of the organic solvent ranges from 5-40%. In the embodiment, the mass fraction of the organic solvent optionally ranges from 10-30%. An adhesive solution is obtained by mixing the adhesive with the organic solvent. The metal powder and the compound powder are uniformly dispersed and suspended in the adhesive solution to form the paste.

In a process of preparing the capillary structure, the paste is coated on the cover plate of the vapor chamber, then the cover plate is dried. After drying, the organic solvent is volatilized, so a layer of metal film is formed on the cover plate to from the matrix of the capillary structure. Then, a high-temperature treatment is performed on the cover plate. Under the high temperature conditions, the compound powder undergoes a decomposition reaction and generates a metal oxide (such as copper oxide) and some volatile small molecular substances (such as water, carbon dioxide, etc.). Under an action of reducing gas, the copper oxide is reduced to pure copper, thereby reducing a volume of the matrix, so that the through holes 1 and the grooves 2 are formed on the capillary structure. A particle size of the through holes 1 reaches a micrometer level. Specifically, the through holes 1 are communicated with each other to from a three-dimensional communicating hole. That is, the through holes 1 communicate with each other and form a three-dimensional space structure. The through holes 1 and the grooves 2 improve a capillary effect of the capillary structure. That is, the through holes 1 and the grooves 2 improve liquid absorption performance of the capillary structure, and thus improving heat transfer performance of the vapor chamber.

With development of technology, electronic products are gradually developed in a direction of miniaturization, which has led to higher requirements on the size and performance of the vapor chamber. In the prior art, the liquid absorbing wick of the vapor chamber generally comprises copper mesh, composite copper mesh, foamed copper, etc. However, the liquid absorbing wick in the prior art not only has high production costs and complex production processes, but also has large dimensions, resulting in a large size of the vapor chamber, so the vapor chamber cannot meet requirements of miniaturization and thinning of the vapor chamber. Compared with the prior art, the capillary structure prepared by the paste of the present disclosure has characteristics of controllable size, high surface quality, and good color. Further, a thickness of the capillary structure of the present disclosure is thin, so the capillary structure meets a size requirement of the vapor chamber. That is, the capillary structure can be applied to an ultra-thin vapor chamber.

Meanwhile, the present disclosure precludes use of additional pore-forming agent (such as ammonium chloride} in the preparing process of the capillary structure. The pore-forming agent generally reacts with the electrolytic copper powder in the paste or reacts with water, thereby promoting reaction between the electrolytic copper powder and carbon dioxide, and then forming green particles, The green particles continue to grow over time, which causes adverse effects on the vapor chamber and the capillary structure. Further, a density of the pore-forming agent is quite different from a density of the electrolytic copper powder, which leads to delamination between different powder in the paste.

The paste in the present disclosure comprises the compound powder, that is, the copper salt powder. The compound powder has better performance than the pore-forming agent and is better combined with the vapor chamber. The compound powder decomposes under the high temperature conditions and generates volatile small molecular substances, so the through holes 1 and the grooves 2 are formed on the capillary structure, which improves the capillary effect of the capillary structure. Therefore, the liquid absorption performance of the capillary structure is improved, and the heat transfer performance of the vapor chamber is improved.

Further, a difference between the density of the compound powder and the density of the electrolytic copper powder is small, thereby reducing possibility of delamination between the compound powder and the electrolytic copper powder during precipitation.

In one optional embodiment, the metal powder is spherical-like copper powder. A particle size of the metal powder ranges from 0.1-100 μm.

The metal powder forms a main portion of the capillary structure. That is, the metal powder forms the matrix constituting the capillary structure, and the metal powder has a submicron-scale spherical-like structure. Optionally, the particle size of the metal powder ranges from 0.3-10 μm.

In one optional embodiment, the compound powder comprises at least one of basic copper carbonate, basic copper sulfate, copper acetate, cuprous sulfite, ammonium cuprous sulfite, and copper ammine complex.

The compound powder is uniformly distributed in the paste by stirring, and a material of the compound powder is selected from one or more of the basic copper carbonate, the basic copper sulfate, the copper acetate, the cuprous sulfite, the ammonium cuprous sulfite, and the copper ammine complex. The compound powder forms the grooves 2 and the through holes 1 on the capillary structure. The specific principles are as follow:

As the temperature increases, the compound powder undergoes the decomposition reaction to generate the copper oxide and the volatile small molecular substances. Under the action of the reducing gas (such as hydrogen), the copper oxide is reduced to the pure copper, so that the volume of the capillary structure reduces and the through holes 1 and grooves 2 are formed on the matrix of the capillary structure.

In the embodiment, when the compound powder is the basic copper carbonate, the compound powder undergoes the decomposition reaction under the high temperature conditions to generate the copper oxide, the water, and the carbon dioxide. The carbon dioxide and the water are volatile. The copper oxide reacts under the action of the hydrogen to generate the pure copper and the water, so the volume of the capillary structure is reduced by 75.32% during a process of forming the grooves and the through holes on the matrix of the capillary structure.

In the embodiment, when the compound powder is the basic copper sulfate, the compound powder undergoes the decomposition reaction under the high temperature conditions to generate the copper oxide, the sulfur dioxide, the oxygen and the water. The sulfur dioxide, the oxygen, and the water are volatile. The copper oxide reacts under the action of the hydrogen to generate the pure copper and the water, so the volume of the capillary structure is reduced by 79.23% during the process of forming the grooves and the through holes on the matrix of the capillary structure.

In the embodiment, when the compound powder is the copper acetate, the compound powder undergoes the decomposition reaction under the high temperature conditions to generate the copper oxide, methane, the water, and the carbon dioxide. The methane, the water, and the carbon dioxide are volatile. The copper oxide reacts under the action of the hydrogen to generate the pure copper and the water, so the volume of the capillary structure is reduced by 95.83% during the process of forming the grooves and the through holes on the matrix of the capillary structure.

In the embodiment, when the compound powder is the copper sulfate, the compound powder undergoes the decomposition reaction under the high temperature conditions to generate the copper oxide and sulfur trioxide. The sulfur trioxide is volatile. The copper oxide reacts under the action of the hydrogen to generate the pure copper and the water, so the volume of the capillary structure is reduced by 83.98% during the process of forming the grooves and the through holes on the matrix of the capillary structure.

In one optional embodiment, a particle size of the compound powder ranges from 100-300 mesh.

Optionally, the particle size of the compound powder ranges from 150-250 mesh.

In one optional embodiment, the adhesive comprises at least one of acrylic resin, epoxy resin, and phenolic resin.

In one optional embodiment, the organic solvent comprises at least one of toluene, xylene, acetone, ethanol, and terpineol.

As shown in FIG. 2, the present disclosure further provides a preparation method of the paste mentioned above. The preparation method of the paste comprises:
S1: grinding the compound powder and sieving the ground compound powder;
S2: adding the adhesive into the organic solvent and stirring under heating conditions to obtain an adhesive solution, where a concentration of the adhesive solution ranges from 5-40%; and
S3: adding the compound powder and the metal powder into the adhesive solution and stirring to obtain the paste.

In the step S1, the compound powder is manually ground or is ground by a pulverizer by performing 3-5 times of pulverization treatments. A duration of each of the pulverization treatments ranges from 1-3 min. Alternatively, the compound powder is put into a ball mill to perform a ball milling treatment. A duration of the ball milling treatment ranges from 4-24 hours. After the compound powder is ground, the ground compound powder is sieved, so as to screen out compound powder particles with suitable particle size. In the step S2, the adhesive is dissolved in the organic solvent and is heated. A heating temperature ranges from 30-80° C., and heating time ranges from 10-240 min. Then, the adhesive solution with a concentration of 5-40% is obtained. In the step S3, the metal powder and the compound powder are sequentially added into the adhesive solution and are stirred for 5-240 min to form the paste. The paste is configured for preparing the capillary structure in the vapor chamber.

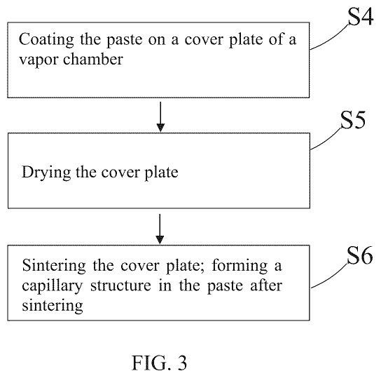

As shown in FIG. 3, the present disclosure further provides a preparation method of the capillary structure. The preparation method of the capillary structure comprises:
S4: coating the paste mentioned above on a cover plate of the vapor chamber;
S5: drying the cover plate; and
S6: sintering the cover plate; forming the capillary structure in the paste after sintering.

In the step S4, a coating method of the paste is blade coating or screen printing. In the step S5, the cover plate is put into an oven for drying. Specifically, a drying temperature ranges from 80-130° C., and drying time ranges from 5-120 min. Thus, the organic solvent is fully volatilized. In the embodiment, the drying temperature optionally ranges from 90-120° C. and the drying time optionally ranges from 5-30 min. The dried cover plate is processed according to the step S6. During a sintering process, the gas generated by the cover plate is discharged in the sintering furnace, the capillary structure is formed by sintering, and the capillary structure is attached to the cover plate.

In one optional embodiment, a step of sintering the cover plate comprises:
S61: sintering the cover plate in a sintering furnace, discharging gas generated by the cover plate, and introducing first gas into the sintering furnace; and
S62: increasing a sintering temperature of the cover plate and sintering the cover plate until the paste forms the capillary structure; then introducing second gas into the sintering furnace.

In the step S61, the first gas introduced into the sintering furnace is nitrogen. The cover plate is sintered at the sintering temperature of 300-650° C. and sintering time ranges from 10-120 min. In the embodiment, the sintering temperature optionally ranges from 400-550° C. and the sintering time optionally ranges from 10-90 min. During this process, the gas generated by the cover plate is discharged. In the step S62, the sintering temperature is continuously increased. Specifically, the sintering temperature thereof is increased to 700-880° C., the sintering time thereof is 5-120 min. In the embodiment, during the step S62, the sintering temperature is 750-850° C., and the sintering time is 10-90 min. During the step S62, the second gas is introduced, and the second gas is mixed gas including nitrogen and hydrogen. After sintering, the capillary structure with the grooves 2 and the through holes 1 is obtained.

The present disclosure further provides a vapor chamber. The vapor chamber comprises the cover plate and the capillary structure. The cover plate comprises a first cover plate and a second cover plate. The first cover plate covers the second cover plate. The capillary structure is disposed on the first cover plate and/or the second cover plate. The capillary structure is prepared by the preparation method of the capillary structure mentioned above. The capillary structure comprises the grooves 2 and the through holes 1. The through holes 1 are communicated with each other. A diameter of each of the through holes 1 ranges from 10-100 μm. A porosity of the capillary structure range from 30-80%. A size of each of the grooves 2 along a width direction of each of the grooves 2 ranges from 10-100 μm.

The vapor chamber is generally used in various electronic components. Since the electronic components generate a lot of heat during operation, the electronic components need to be dissipated and cooled. The vapor chamber is configured to evenly distribute the heat of the electronic components, and then the heat is dissipated through a radiator. A working principle of the vapor chamber is as follows:

In use of the vapor chamber, a first end of the vapor chamber close to a heat source is defined as a hot end, and a second end of the vapor chamber away from the heat source is defined as a cold end. A steam channel is defined in the hot end. The working fluid in the vapor channel is vaporized and absorbs heat, thereby carrying the heat away. Then the vaporized working fluid flows from the hot end to the cold end through the steam channel, and the vaporized working fluid liquefies at the cold end to release heat. Then the liquefied working fluid flows from the cold end to the hot end again through the capillary structure. The working fluid is vaporized and liquefied in a cycle and that cycle repeats, so as to achieve the heat transfer effect.

The vapor chamber comprises the first cover plate, the second cover plate, the liquid absorbing wick, and the working fluid. The liquid absorbing wick comprises the capillary structure, and the capillary structure provides the power of backflow for the working fluid, thereby facilitating the heat transfer of the vapor chamber. Specifically, the capillary structure may be arranged on the first cover plate, and the second cover plate defines the steam channel. The first cover plate covers the second cover plate to obtain the vapor chamber having the heat transfer effect. Alternatively, the capillary structure is arranged on the second cover plate, and the steam channel is defined in the first cover plate. The capillary structure is prepared by the preparation method of the capillary structure mentioned above. As shown in FIG. 1, the capillary structure has a plurality of the micron-scale grooves 2 and a plurality of the micron-scale through holes 1. The diameter of each of the through holes 1 ranges from 10-100 μm. The porosity of the capillary structure reaches 30-80%, and the through holes 1 communicate with each other to form the three-dimensional communicating hole having the three-dimensional space structure. The width d of each of the grooves 2 ranges from 10-100 μm. The grooves 2 on the capillary structure is conducive to improving the capillary effect of the capillary structure, thereby improving the liquid absorption performance of the capillary structure, and thus improving the overall heat transfer performance of the vapor chamber.

In the present disclosure, following specific embodiments are provided as examples.

### Embodiment 1

The xylene solution including polymethylmethacrylate (PMMA) is prepared, where a mass fraction of the PMMA is 30%. Then the electrolytic copper powder having the mass fraction of 30% and the basic copper carbonate powder having the mass fraction of 45% are added into the xylene solution, where the electrolytic copper powder is submicron and the basic copper carbonate powder is sieved after grinding or ball milling. The xylene solution, the electrolytic copper powder, and the basic copper carbonate powder are fully stirred in a mixer for 0.5-4 h to obtain the paste. The mixed paste is coated on the first cover plate of the vapor chamber by blade coating or screen printing. Then the first cover plate with the coated paste is dried in the oven at the temperature of 90-120° C. for 5-30 min. After the organic solvent is volatilized, the first cover plate is put into the sintering furnace, and the nitrogen is introduced to discharge the gas generated by the first cover plate at 400-550° C. for 10-90 min. Then, the mixed gas of the nitrogen and the hydrogen is introduced into the sintering furnace, and the first cover plate is sintered at the temperature of 750-850° C. for 10-90 min to obtain the first cover plate with the capillary structure. The first cover plate and the second cover plate are bonded together by solder paste to obtain the vapor chamber. A temperature difference between the cold end and the hot end of the vapor chamber is tested, and a test result is 2.3° C.

### Embodiment 2

The xylene solution including the PMMA is prepared, where the mass fraction of the PMMA is 30%. Then the electrolytic copper powder having the mass fraction of 55% and the basic copper carbonate powder having the mass fraction of 25% are added into the xylene solution, where the electrolytic copper powder is submicron and the basic copper carbonate powder is sieved after grinding or ball milling. The xylene solution, the electrolytic copper powder, and the basic copper carbonate powder are fully stirred in the mixer for 0.5-4 h to obtain the paste. The mixed paste is coated on the first cover plate of the vapor chamber by blade coating or screen printing. Then the first cover plate with the coated paste is dried in the oven at the temperature of 90-120° C. for 5-30 min. After the organic solvent is volatilized, the first cover plate is put into the sintering furnace, and the nitrogen is introduced to discharge the gas generated by the first cover plate at 400-550° C. for 10-90 min. Then, the mixed gas of the nitrogen and the hydrogen is introduced into the sintering furnace, and the first cover plate is sintered at the temperature of 750-850° C. for 10-90 min to obtain the first cover plate with the capillary structure. The first cover plate and the second cover plate are bonded together by the solder paste to obtain the vapor chamber. The temperature difference between the cold end and the hot end of the vapor chamber is tested, and the test result is 1.5° C.

### Embodiment 3

The xylene solution including the PMMA is prepared, where the mass fraction of the PMMA is 30%. Then the electrolytic copper powder having the mass fraction of 55% and the basic copper sulfate powder having the mass fraction of 25% are added into the xylene solution, where the electrolytic copper powder is submicron and the basic copper sulfate powder is sieved after grinding or ball milling. The xylene solution, the electrolytic copper powder, and the basic copper sulfate powder are fully stirred in the mixer for 0.5-4 h to obtain the paste. The mixed paste is coated on the first cover plate of the vapor chamber by blade coating or screen printing. Then the first cover plate with the coated paste is dried in the oven at the temperature of 90-120° C. for 5-30 min. After the organic solvent is volatilized, the first cover plate is put into the sintering furnace, and the nitrogen is introduced to discharge the gas generated by the first cover plate at 400-550° C. for 10-90 min. Then, the mixed gas of the nitrogen and the hydrogen is introduced into the sintering furnace, and the first cover plate is sintered at the temperature of 750-850° C. for 10-90 min to obtain the first cover plate with the capillary structure. The first cover plate and the second cover plate are bonded together by the solder paste to obtain the vapor chamber. The temperature difference between the cold end and the hot end of the vapor chamber is tested, and the test result is 2.0° C.

### Embodiment 4

The xylene solution including the PMMA is prepared, where the mass fraction of the PMMA is 30%. Then the electrolytic copper powder having the mass fraction of 55% and the copper acetate powder having the mass fraction of 25% are added into the xylene solution, where the electrolytic copper powder is submicron and the copper acetate powder is sieved after grinding or ball milling. The xylene solution, the electrolytic copper powder, and the copper acetate powder are fully stirred in the mixer for 0.5-4 h to obtain the paste. The mixed paste is coated on the first cover plate of the vapor chamber by blade coating or screen printing. Then the first cover plate with the coated paste is dried in the oven at the temperature of 90-120° C. for 5-30 min. After the organic solvent is volatilized, the first cover plate is put into the sintering furnace, and the nitrogen is introduced to discharge the gas generated by the first cover plate at 400-550° C. for 10-90 min. Then, the mixed gas of the nitrogen and the hydrogen is introduced into the sintering furnace, and the first cover plate is sintered at the temperature of 750-850° C. for 10-90 min to obtain the first cover plate with the capillary structure. The first cover plate and the second cover plate are bonded together by the solder paste to obtain the vapor chamber. The temperature difference between the cold end and the hot end of the vapor chamber is tested, and the test result is 1.9° C.

### Embodiment 5

The terpineol solution including polybutylmethacrylate (PBMA) is prepared, where the mass fraction of the PBMA is 25%. Then the electrolytic copper powder having the mass fraction of 50% and the basic copper carbonate powder having the mass fraction of 30% are added into the terpineol solution, where the electrolytic copper powder is submicron and the basic copper carbonate powder is sieved after grinding or ball milling. The terpineol solution, the electrolytic copper powder, and the basic copper carbonate powder are fully stirred in the mixer for 0.5-4 h to obtain the paste. The mixed paste is coated on the first cover plate of the vapor chamber by blade coating or screen printing. Then the first cover plate with the coated paste is dried in the oven at the temperature of 90-120° ° C. for 5-30 min. After the organic solvent is volatilized, the first cover plate is put into the sintering furnace, and the nitrogen is introduced to discharge the gas generated by the first cover plate at 400-550° C. for 10-90 min. Then, the mixed gas of the nitrogen and the hydrogen is introduced into the sintering furnace, and the first cover plate is sintered at the temperature of 750-850° C. for 10-90 min to obtain the first cover plate with the capillary structure. The first cover plate and the second cover plate are bonded together by the solder paste to obtain the vapor chamber. The temperature difference between the cold end and the hot end of the vapor chamber is tested, and the test result is 1.6° C.

The above are only the embodiments of the present disclosure. It should be pointed out that for those skilled in the art, improvements can be made without departing from the inventive concept of the present disclosure, and these improvements fall within the protection scope of the present disclosure.

What is claimed is:

1. Paste for preparing a capillary structure, comprising:
metal powder;
compound powder;
adhesive; and
organic solvent;
wherein a mass fraction of the metal powder in the paste ranges from 20-80%; a mass fraction of the compound powder in the paste ranges from 10-70%; a mass fraction of the adhesive in the paste ranges from 0.1-20%; a mass fraction of the organic solvent in the paste ranges from 5-40%;
wherein the organic solvent is configured for dissolving the adhesive; the adhesive is configured for bonding the metal powder and the compound powder to a vapor chamber; the metal powder forms a matrix of the capillary structure in the vapor chamber after drying; the compound powder forms grooves and through holes on the matrix.

2. The paste for preparing the capillary structure according to claim 1, wherein the metal powder is spherical-like copper powder; a particle size of the metal powder ranges from 0.1-100 μm.

3. The paste for preparing the capillary structure according to claim 1, wherein the compound powder comprises at least one of basic copper carbonate, basic copper sulfate, copper acetate, cuprous sulfite, ammonium cuprous sulfite, and copper ammine complex.

4. The paste for preparing the capillary structure according to claim 3, wherein a particle size of the compound powder ranges from 100-300 mesh.

5. The paste for preparing the capillary structure according to claim 1, wherein the adhesive comprises at least one of acrylic resin, epoxy resin, and phenolic resin.

6. The paste for preparing the capillary structure according to claim 1, wherein the organic solvent comprises at least one of toluene, xylene, acetone, ethanol, and terpineol.

7. A preparation method of the paste for preparing the capillary structure according to claim 1, comprising:
grinding the compound powder and sieving the ground compound powder;
adding the adhesive into the organic solvent and stirring under heating conditions to obtain an adhesive solution where a concentration of the adhesive solution ranges from 5-40%; and
adding the compound powder and the metal powder into the adhesive solution and stirring to obtain the paste.

8. A preparation method of the capillary structure, comprising:
coating the paste according to claim 1 on a cover plate of the vapor chamber;
drying the cover plate; and
sintering the cover plate; forming the capillary structure in the paste after sintering.

9. The preparation method of the capillary structure according to claim 8, wherein a step of sintering the cover plate comprises:
sintering the cover plate in a sintering furnace, discharging gas generated by the cover plate, and introducing first gas into the sintering furnace; and
increasing a sintering temperature of the cover plate and sintering the cover plate until the paste forms the capillary structure; then introducing second gas into the sintering furnace.

10. A vapor chamber, comprising:
the cover plate; and
the capillary structure;
wherein the cover plate comprises a first cover plate and a second cover plate, the first cover plate covers the second cover plate; the capillary structure is disposed on the first cover plate and/or the second cover plate; the capillary structure is prepared by the preparation method according to claim 9;
wherein the capillary structure comprises the grooves and the through holes; the through holes are communicated with each other; a diameter of each of the through holes ranges from 10-100 μm; a porosity of the capillary structure range from 30-80%; and a size of each of the grooves along a width direction of each of the grooves ranges from 10-100 μm.
